(19) United States
(12) Patent Application Publication
(10) Pub. No.: US 2005/0251962 A1
(43) Pub. Date: Nov. 17, 2005

(54) Hinge arrangment for a cabinet door

(76) Inventors: Paulo Sergio Negreiros De Mello, Joinville-SC (BR); Mara Sol Da Silva De Mello, Joinville-SC (BR); Eduardo Jose Bolivar Sao Clemente, Joinville-SC (BR); Marcos Heinzle, Joinville-SC (BR)

Correspondence Address: Darby & Darby, PO Box 5257, New York, NY, 10150-5257, US

(21) Appl. No.: 10/432,540

(22) PCT Filed: Nov. 28, 2001
(86) PCT No.: PCT/BR01/00147

§ 371 Date: May 6, 2005

(30) Foreign Application Priority Data
Dec. 4, 2000 (BR) PI0006260-0

(51) Int. Cl. E05D 7/10

(52) U.S. Cl. 16/262

(57) ABSTRACT

A hinge arrangement for a cabinet door, comprising: a pair of hinge seats (10), which are affixed to one of the parts defined by the door (P) and the cabinet (G); hinge pins (20), which are affixed to the other of said parts and which are each designed to be fitted into a respective hinge seat (10) when the respective side of the door is closed; a locking slide (30), which is mounted to the hinge seats (10), and which may be displaced in opposite directions, as a function of the door opening operation, in order to lock the hinge pin (20) inside the respective hinge seat (10) at the non-opened side of the door, said hinge arrangement further comprising a first stop means (15) incorporated to each hinge seat (10), and a second stop means (25), which is fixed and slightly spaced in relation to each hinge pin (20), said first and second stop means (15, 25) being arranged so that, after the door (P) has been opened by a certain degree from one side, the first stop means (15) of the other side is angularly displaced, in order to cooperate with the second stop means (25), avoiding said hinge pin (20) from being liberated from its hinge seat (10), regardless of the positioning of the locking slide (30).

### FIELD OF THE INVENTION

The present invention refers to a hinge arrangement, which allows opening and closing the cabinet door of refrigeration appliances or similar products, from either the right side or the left side of the door.

### BACKGROUND OF THE INVENTION

It is known from the prior art the use of a hinge arrangement for the cabinet door of a refrigeration appliance, which allows said door to be opened and closed from any one of the sides thereof, comprising: four hinge seats, usually in the form of slots provided in plates, which are each horizontally affixed close to one of the upper and lower ends of the door or of the cabinet and close to the right and left portions thereof. In each of said slots are fitted, when the door is angularly horizontally displaced, a vertical hinge pin affixed to the other of said parts defined by the door and the cabinet, upon closing the respective side of the door. In order to guarantee that the hinge pins of the door side opposite to that selected by the user for opening the door remain retained inside the respective hinge seats, journalling and defining the articulation for the opening/closing rotation of the door, there is provided a locking slide, usually in the form of an elongated bar, which is guided on that part defined by the door or the cabinet which sustains the hinge seats, so that said locking slide may be linearly displaced in opposite directions, from a median closed door position, towards either of the sides of the door or the cabinet.

The opposite ends of the locking slide are provided with respective cam portions, which are arranged so that the locking slide be displaced by the hinge pin of the door side selected to be opened towards the other side, in order to lock the hinge pin of said other side inside the respective hinge seat. Thus, when door opening is initiated from any of the sides, the locking slide is automatically and immediately forced to move to the other side, locking the hinge pin of said other side and preventing the door from being displaced from the cabinet while it is kept in the open position.

The locking slide is medianly provided with a marginal V shaped cut, in order to work jointly with a positioning pin, which is mounted so as to be pressed when contacting the other part defined by either the door or the cabinet, against the V shaped cut, upon the door reaching a position immediately anterior to the closing thereof. In such situation, the positioning pin presses one of the inclined walls of the V shaped cut, forcing the locking slide to the median position and allowing, with the door completely closed, the hinge pins to be adequately locked in their respective hinge seats by the cam portions in the opposite ends of the locking slide, preventing the door from being detached from the cabinet.

In this type of construction mentioned above, the locking of the hinge pins is assured by the locking slide in the open door condition and it is not possible for the door to fall, since the opening thereof by any of the sides may only be achieved as a function of the dimensioning of the locking slide, with the latter being displaced to the other side, to a mandatory condition in which the hinge pin is locked to said other side.

However, when the door is in the open condition on one side, with the locking slide displaced to the other side, it is possible for the user to manually press the positioning pin, which is mounted to the part defined by either the door or the cabinet that carries the locking slide, towards the V shaped cut of the latter, in order to cause the displacement of the locking slide to the median position, from which the door may be pulled outwardly from the hinged side, so that the hinge pin of this side acts on the adjacent cam portion of the locking slide, forcing it to move towards the already opened side and fully liberating the door from its connection with the cabinet.

The completely liberated door condition mentioned above is only possible in case the user deliberately and unduly acts on the positioning pin, manually forcing it against the locking slide. However, in case said condition occurs inadvertently or by action of children, the door may fall, seriously hurting the user and causing material damage.

It should be noted that, even in the constructions in which the positioning pin is affixed to the door provided with the hinge pins, it is possible for the user to insert any kind of pin in the orifice of the other part that gives access to the V shaped cut of the locking slide, forcing the latter to the median position, from which it may be displaced by the hinge pin itself when the respective side of the door is forced to open.

### OBJECT OF THE INVENTION

It is a general object of the invention to provide a hinge arrangement for a cabinet door of the type considered herein and presenting, by means of a very simple construction, a safety device for preventing the door from being detached from the cabinet by deliberately or inadvertently displacing the locking slide to the median position, after the door has been opened by one of its sides.

### SUMMARY OF THE INVENTION

The object above is achieved by the provision of a hinge arrangement for a cabinet door, comprising: a pair of hinge seats, which are affixed close to each of the upper and lower ends of one of the parts defined by the door and the cabinet, symmetrically in relation to the center line of said parts, in their right and left end portions, respectively; hinge pins, which are affixed to the other of said parts defined by the door and cabinet and which are each designed to be fitted into a respective hinge seat when the respective side of the door is closed; a locking slide, which is mounted to each of the upper and lower ends of the part defined by the door or the cabinet that carries the hinge seats, and which may be displaced in opposite directions from a median position, said locking slide being provided, at its opposite ends, with cam portions, which are arranged in order that, in the initial phase in which the door is opened by one of its sides, the hinge pin of said side, acting on the adjacent cam portion, causes the displacement of the locking slide in order to lock the hinge pin of the other side of the door inside the respective hinge seat.

According to the invention, the hinge arrangement further comprises a first stop means incorporated to each hinge seat, and a second stop means, which is fixed and slightly spaced in relation to each hinge pin, said first and second stop means being arranged so that, after the door has been opened by a certain degree from one side, the first stop means of the other side is angularly displaced around the respective hinge pin, from an inoperative position, in which it allows the liberation of said hinge pin from its hinge seat, to an operative position, in which it cooperates with the second stop means, avoiding said hinge pin from being liberated from its hinge seat, regardless of the locking slide being positioned in its median position.

With the construction cited above, after the door has been opened from one of its sides, by an angle sufficient to allow the user to access the positioning pin or the orifice that gives access to the V shaped cut of the locking slide, the stop means of the other side of the door are correspondingly angularly displaced relative to each other, from an inoperative position, in which they allow the adjacent hinge pins to be liberated from the fitting condition in the respective hinge seats, to an operative condition, in which they begin to mutually cooperate, locking the respective hinge pins in the respective hinge seats, even if the locking slide is unduly displaced to its median position, from which said non-opened side of the door may be detached from the cabinet if pulled by the user.

### BRIEF DESCRIPTION OF THE DRAWINGS

The invention will be described below, with reference to the attached drawings, in which:

FIG. 1 is a schematic upper plan view of the lower hinge arrangement of the present invention, with the door in the closed position;

FIG. 2 illustrates an enlarged detail of part of FIG. 1, with the locking slide being partially cut at the end facing the side of the door to be kept articulated to the cabinet in a desired opening operation, in order to better illustrate the first and second stop means;

FIG. 3 is a similar view to that of FIG. 1, but with the door in a partially open condition;

FIG. 4 is a similar view to that of FIG. 2, but illustrating the same elements with the door in the already opened condition;

FIG. 5 is a similar view to that of FIG. 4, but illustrating the opposite end of the partially opened door;

FIG. 6 is a perspective view of an assembly comprising, in a single piece, a hinge pin and a door positioning means, said assembly being disposed to cooperate with the lower portion of a door when affixed to the cabinet.

FIG. 7 is a partially cut perspective view of a support plate, onto which is incorporated a pair of hinge pins, which are horizontally leveled at the lower end of the cabinet;

FIG. 8 is a partially cut lower perspective view of a door of a refrigerator or freezer, to whose lower edge is mounted a seating plate, on which are formed two horizontally leveled hinge seats; and

FIG. 9 is a partially sectional vertical view of an assembly comprising the cabinet and the almost closed door incorporating the seating plates and the support plates.

### DESCRIPTION OF THE ILLUSTRATED EMBODIMENT

As mentioned above, the hinge arrangement of the present invention is particularly adequate for providing the coupling of doors with automatical reversible opening to the cabinets of refrigerators or freezers.

The arrangement considered herein is of the type comprising four hinges in each door P, which are provided in pairs at the upper part and at the lower part of the door P, the hinges of each pair being provided close to the right and left end portions of said door P, respectively, and symmetrically in relation to the longitudinal axis of the door P or of the front face of the cabinet G.

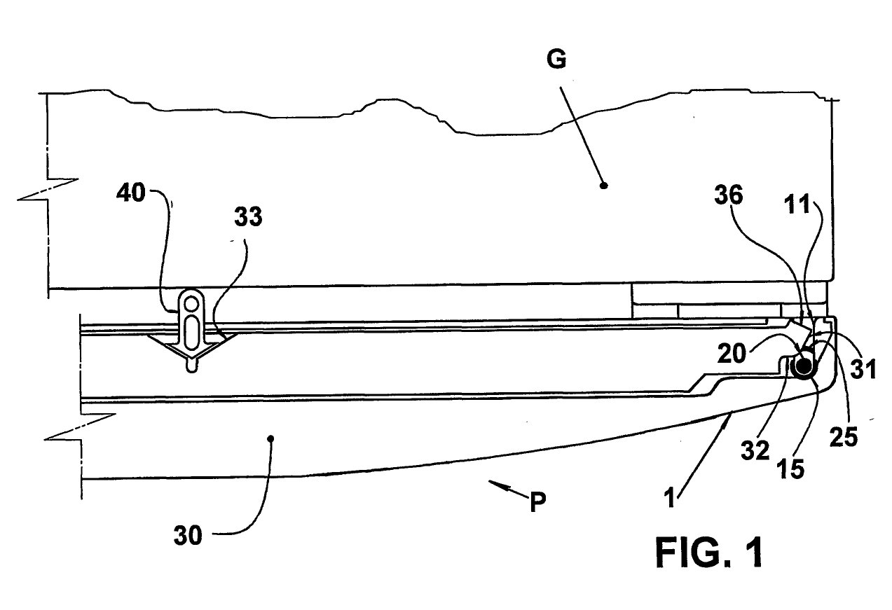

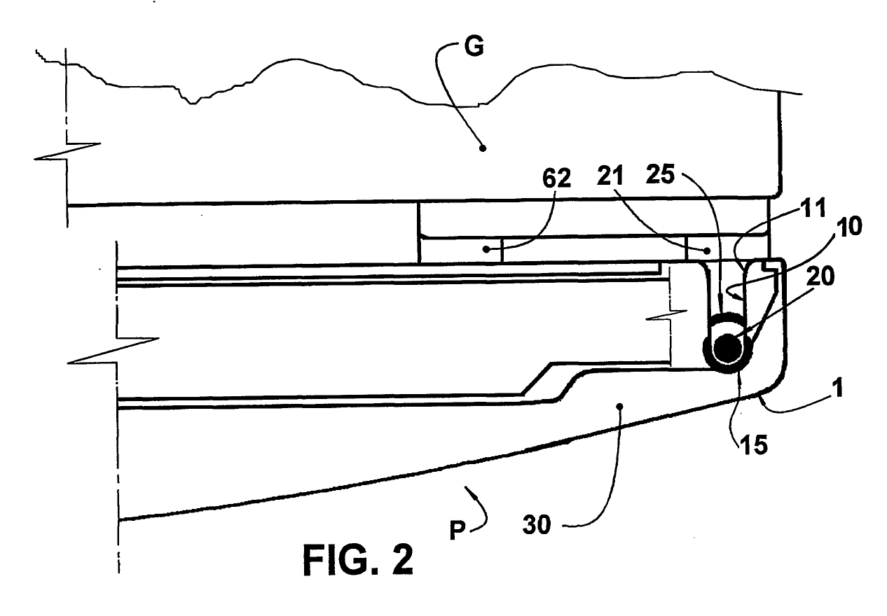

Each of said hinges comprises a hinge seat 10, which takes the form of a slot provided in a seating plate 1, horizontally affixed to the upper and lower ends of either the door P or the cabinet G, said slot having its axis usually provided transversal to the plane of the closing face of the part that carries said hinge seat 10, and having an open end portion 11 facing the front face of cabinet G, and a closed end portion 12 opposite to the open end portion 11 and in the form of a semicircle coinciding with the lateral edges of the slot, the radius of said closed end portion being slightly larger than that of a respective hinge pin 20, which defines the other element of each hinge and which is affixed to the other part consisting of the door P or the cabinet G, in order to be fitted into a respective hinge seat 10 upon closing the door, as illustrated in FIGS. 1 and 2. The fitting of each hinge pin 20 inside the respective hinge seat 10 is achieved by displacing the former along the slot that defines the hinge seat 10.

On the same part consisting of either the door P or the cabinet G that carries the hinge seats 10 is mounted a locking slide 30, usually in the form of an elongated bar disposed parallel to the plane of the closing face of the part that carries it, so that it may be linearly displaced in opposite directions and from a median position corresponding to a closed door position (FIGS. 1 and 2).

Each end of the locking slide 30 is configured to define a cam portion 31 in the form of an inclined ramp, which remains seated against the respective hinge pin 20 when in the closed door condition, as illustrated in FIGS. 1 and 2. In this condition, in case the door P is pulled outwardly, simultaneously by both right and left sides, the two opposite cam portions 31 will avoid the liberation of the hinge pins 20 fitted in the respective hinge seats.

In order to open the door P, all the user has to do is to pull one of the sides thereof away from the cabinet G, making the force of both hinge pins 20 of this side of the door on the adjacent cam portions 31 of both locking slides 30 to provoke the linear displacement of the latter towards the other side of the door-cabinet assembly, so that a locking portion 32 of both locking slides 30 be positioned against the respective hinge pins 20, locking the latter, avoiding the liberation of the respective hinge seats 10 and consequently maintaining the door P articulated to the cabinet G during opening thereof.

As is known from the prior art, each pair of hinge seats 10 is usually provided in a frame, at least partially tubular, in which is guided a respective locking slide 30. Said frame is preferably mounted in the upper and lower end regions of door P. However, it should be understood that mounting the assembly formed by a pair of hinge seats 10 and by a locking slide 30 may be equally effected in the upper and lower ends of the cabinet G, in which case the hinge pins 20 are attached to the door P.

In the figures of the appended drawings, the hinge pins 20 are attached to the cabinet G, while the hinge seats 10 and both locking slides 30 are mounted to the door P, with the description below being directed to this constructive option.

In order that the locking slide 30 be automatically and safely returned to the median position, after the door P has been closed, in which position the cam portions 31 are again positioned against the respective hinge pins 20, said locking slide 30 is medianly provided, on its longitudinal side turned to the front face of the cabinet G, with a V shaped cut 33, against which is pressed a positioning pin 40 which, in the illustrated embodiment, is mounted in the guiding frame of the locking slide 30, in an axially displaceable manner.

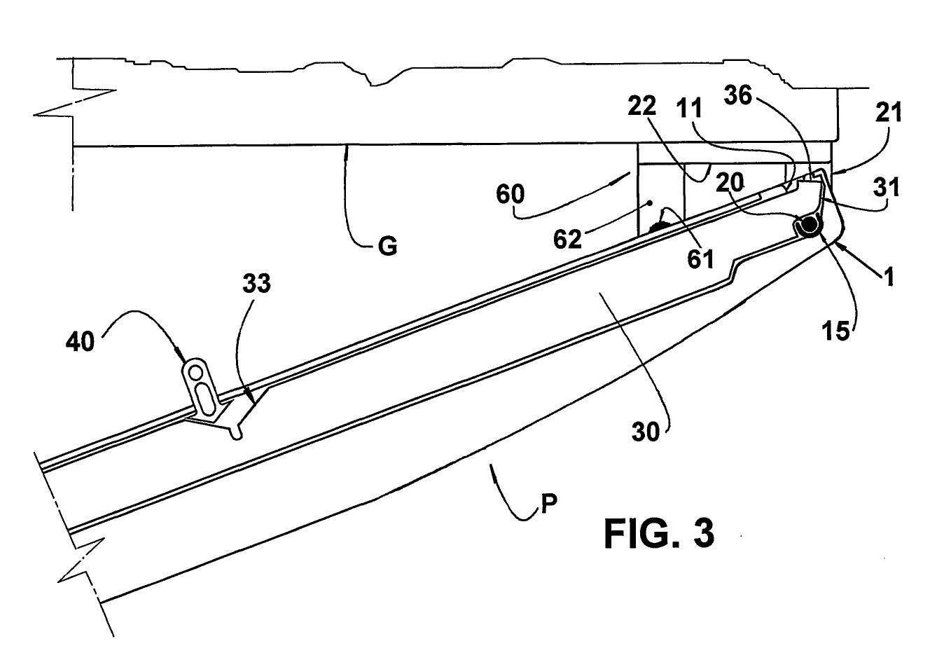

Thus, when a side of the door P is opened and the locking slide 30 is displaced to the opposite side, one of the sides of the V shaped cut 33 causes the displacement of the positioning pin 40 to the outermost region of the V shaped cut 33, whereby said positioning pin 40 becomes more salient in relation to the adjacent longitudinal side of the locking slide 30, as illustrated in FIG. 3.

When the door P is returned to the closed position, the positioning pin 40 touches a surface of the cabinet in the final closing course, so that, as soon as the cam portion 31 of the open end of the locking slide 30 reaches, together with the door, a position that is posterior to that in which the adjacent hinge pin 20 is fitted in the respective hinge seat 10, said positioning pin 40 forces the locking slide 30 back to the median position, resetting the latter to a new door opening by any one of the right or left sides of said door.

While being preferred to mount the positioning pin 40 in an axially sliding way to the part carrying the hinge seats 10 and the locking slides 30, it should be understood that said positioning pin may be affixed to the other of said parts defined by the cabinet G and door P.

In any of the constructions for the positioning pin 40 mentioned above, after the door P has been opened by a certain degree, such as that illustrated in FIG. 3, it is possible for any person to access the V shaped cut 33 of the locking slide 30, by pressing the movable positioning pin 40 or using any other similar instrument that exerts a transversal force on one of the sides of the V shaped cut 33, in order to provoke the displacement of the locking slide 30 to the median position, in which the application of the opening force onto the hinged side of the door will cause, by action of the hinge pin 20 against the adjacent cam portion 31 of the locking slide 30, the latter to be further displaced towards the open side of the door P, completely detaching said door from the cabinet G.

For preventing said door P from being detached from the cabinet G, the present hinge arrangement is provided with a first stop means 15 in the form of a semi-circular projection incorporated to each hinge seat 10 and concentrically internally coinciding with the contour of the closed end portion 12 of the slot that defines each hinge seat 10, that is, having an inner radius of curvature that is slightly larger than the radius of the hinge pin 20.

The present hinge arrangement further comprises a second stop means 25, which is affixed to the part of either the door P or to the cabinet G carrying the hinge pins 20, each second stop means 25 comprising a semi-circular wall, which has an inner radius of curvature that is larger than the outer radius of curvature of the first stop means 15, and which is concentric and radially spaced from a respective hinge pin 20 by a distance slightly larger than the radial thickness of the first stop means 15 in the form of a semi-circular projection.

The first and the second stop means 15, 25 are disposed substantially concentric and having the same axis of symmetry coinciding with the axis of the slot that defines the hinge seat 10, the chord of the second stop means 25 cutting the end portions of the first stop means 15 when the door P is in the closed position illustrated in FIGS. 1 and 2. In this condition, the first and second stop means remain in an inoperative condition.

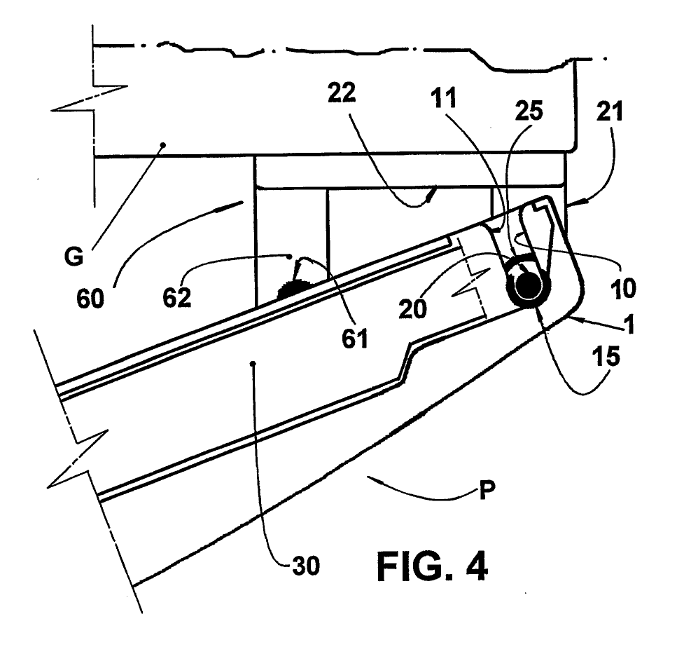

When the door is opened by one side, the first stop means 15 of the other side and the associated hinge seat 10 are rotated around the respective hinge pin 20, soon reaching an operative position in which the axis of the slot of the hinge seat 10 no longer coincides with the axis of symmetry of the second stop means 25, as illustrated in FIG. 4. In this condition, the relative displacement of the hinge pin 20-second stop means 25 along the slot of the hinge seat 10 and outwardly from the latter is avoided by the interference between the first and the second stop means 15, 25.

With the door P submitted to an opening of about 90° or slightly less, the rotation of the first stop means 15 around the hinge pin 20 reaches a condition in which it still cooperates with the hinge pin 20, defining an obstacle to the liberation path of the latter in relation to the respective hinge seat in which it is fitted and retained.

Thus, after the door has been opened by either of the sides thereof, the stop means of the side that remained articulated to the cabinet begin to interact, in order to guarantee the locking of the hinge pins 20 in the respective hinge seats 10, regardless of the position of the locking slide 30.

In order to assure that the locking slide 30 is displaced to the hinged side of the door P upon closing thereof, each end of the locking slide 30 is further provided with a ramp 36, which is disposed on the longitudinal side provided with the V shaped cut 33 and which, by hitting a hinge pin 20 when the respective side of the door P is closed, forces the locking slide 30 to move to the other side, allowing it to pass by said hinge pin 20. Then, the positioning pin 40, by touching the other part of the door-cabinet assembly, forces the locking slide 30 to move back to the median position.

Due to the fact that the constructions of refrigerator doors, in which the opening may be achieved by either of the sides thereof, require a correct vertical positioning of said door during the final closing phase of the opened side, it is known the provision of support elements mounted to the door and to the cabinet and which mutually cooperate, in the condition in which the door is in the final closing phase, and in the complete closing phase, in order to assure that the door, even supporting the weight of its loaded inner shelves, has its opened side taken to its correct position, in the vertical direction, upon approaching the cabinet, so that the hinge pins of this same side may be correctly and smoothly engaged to the respective hinge seats in the final closing phase of this side of the door.

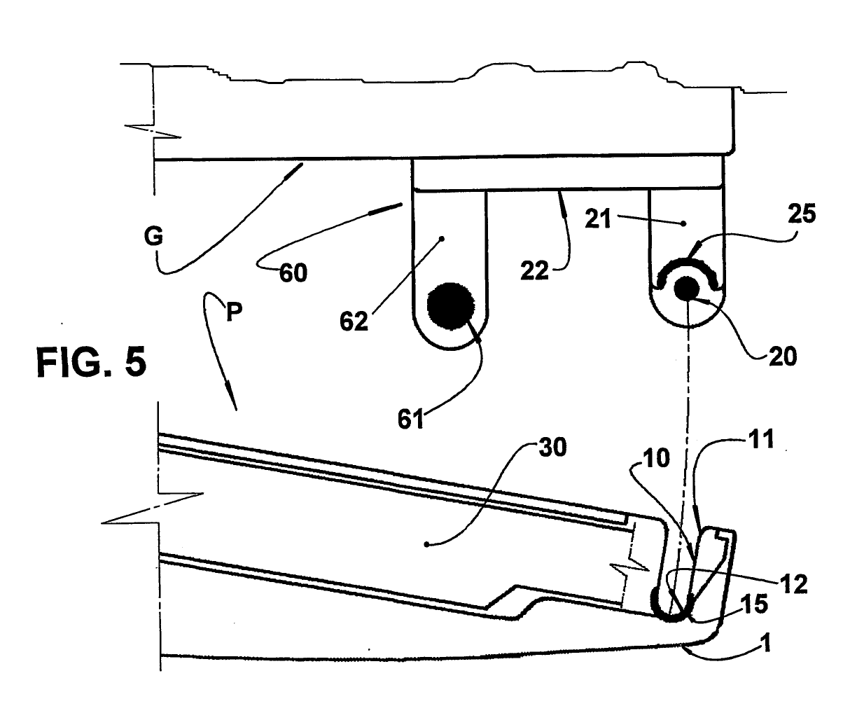

As shown in FIGS. 3, 4, 5 and 6 of the appended drawings, on each side of the door-cabinet assembly there is provided a support element 60, designed to support the weight of the door P in the final closing phase and which is preferably affixed to the cabinet G, in order to cooperate with a lower surface portion of the door P, from a certain closing condition of the latter.

In the embodiment cited above, the support element 60 comprises a rolling element 61, such as a ball or a roller, which is partially lodged and retained in a recess of a frame 62 and rotating freely when subject to tangential efforts in its spherical or cylindrical surface portion projecting from the frame 62. The frame 62 may be attached to any of the parts defined by the door P and the cabinet G, so that the ball 61 may operate against a surface (not illustrated), usually in the form of a ramp and provided in the other of said parts when the door P is closed, in order to force the door P to assume a project nominal leveling, adequate to the correct operation of the hinge arrangement with automatic reversible opening.

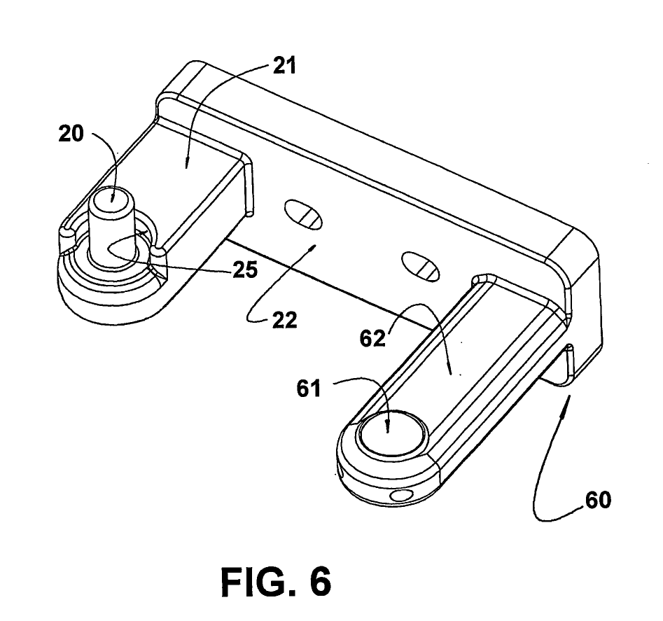

In FIG. 6 there is illustrated a construction in which the hinge pin 20 is mounted to a rod 21 projecting from a base 22 to be affixed, for example by non-illustrated screws, to the front face of cabinet G, which base 22 may incorporate, also in a single piece, the frame 62 carrying a ball shaped rolling element 61, of the support element 60, preferably mounted to the cabinet G to act under the lower end portion of the door P.

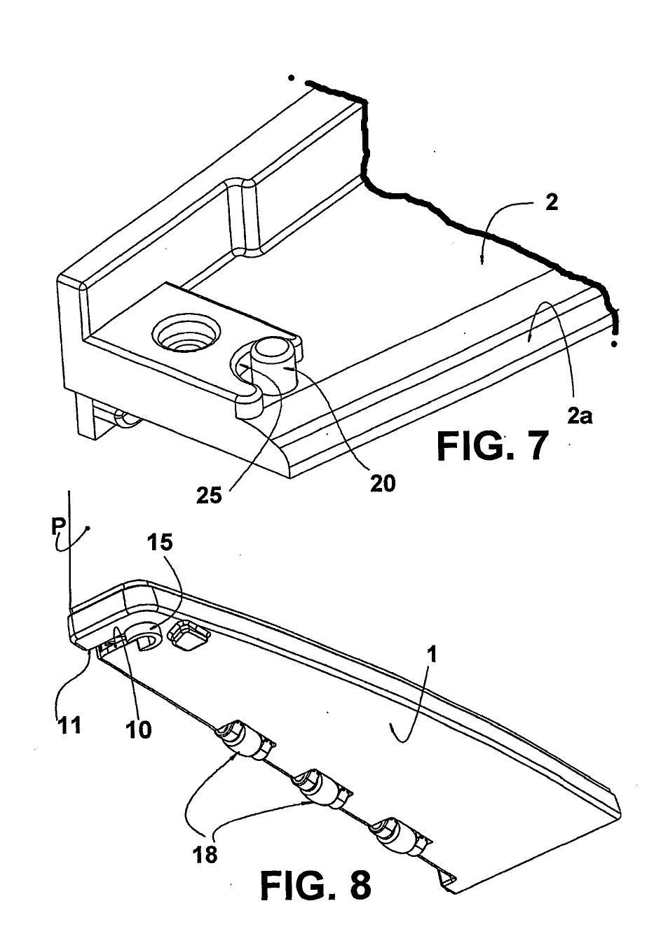

In the embodiment shown in FIGS. 7, 8 and 9, a pair of horizontally leveled hinge seats 10, usually attached to the lower end of door P, is formed in a single seating plate 1 affixed along the width of the lower edge of the door P and which is provided in its lower edge with a plurality of free rotating rollers 18, which are adequately journalled on respective shaft extensions 19, which are usually coaxial to each other and parallel to said front edge of said seating plate 1, in order to allow the contour of the cylindrical surface of the rollers 18 to slightly project outwardly from the free external face of the seating plate 1.

The constructive solution of the hinge seat mentioned above is designed to operate jointly with a respective pair of hinge pins 20 incorporated in a single support plate 2 which, in the illustrated construction, is affixed to the lower portion of the cabinet G, defining the lower threshold of the door P.

As it may be observed from the drawings, both the hinge seats 10 incorporated to the respective lower seating plate 1 of the door P and the hinge pins 20 incorporated to the respective support plate 2 of the cabinet G are provided with the respective first stop means 15 and second stop means 25, as already described in relation to FIGS. 1-6.

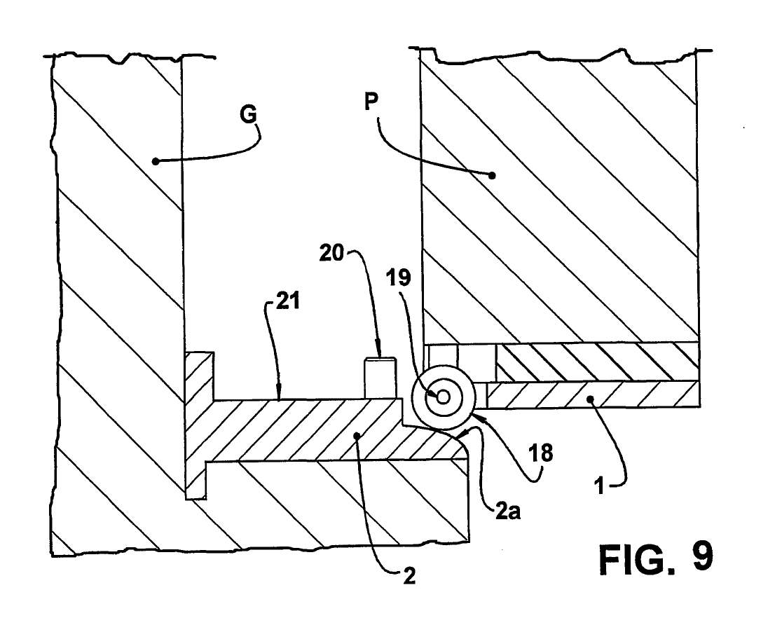

The support plate 2 is provided with a front edge 2a in the form of a smooth ramp, against which are seated the rollers 18 during the final closing phase of the door P, as schematically illustrated in FIG. 9. The rollers 18 follow the front edge 2a of the support plate 2, guaranteeing the correct leveling of the door immediately before the hinge means of the opened side initiate a new mutual operational contact.

While having been illustrated an arrangement in which the seating 1 is mounted to the lower edge of the door P, it should be understood that it is also possible to mount the seating plate 1 to the cabinet G and the support plate 2 to the door P. It is also possible to associate the rollers 18 to the support plate 2 affixed to the cabinet G, producing an inverted ramp on the seating plate 1.

1. A hinge arrangement for a cabinet door, comprising: a pair of hinge seats (10), which are affixed close to each of the upper and lower ends of one of the parts defined by the door (P) and the cabinet (G), symmetrically in relation to the center line of said parts, in their right and left end portions, respectively; hinge pins (20), which are affixed to the other of said parts and which are each designed to be fitted into a respective hinge seat (10) when the respective side of the door is closed; a locking slide (30), which is mounted to each of the upper and lower ends of the part that carries the hinge seats (10), and which may be displaced in opposite directions from a median position, said locking slide being provided, at its opposite ends, with cam portions (31), which are arranged in order that, in the initial phase in which the door (P) is opened by one of its sides, the hinge pin (20) of said side, acting on the adjacent cam portion (31), causes the displacement of the locking slide (30) in order to lock the hinge pin (20) of the other side of the door inside the respective hinge seat (10), characterized in that it comprises a first stop means (15) incorporated to each hinge seat (10), and a second stop means (25), which is fixed and slightly spaced in relation to each hinge pin (20), said first and second stop means (15, 25) being arranged so that, after the door (P) has been opened by a certain degree from one side, the first stop means (15) of the other side is angularly displaced around the respective hinge pin (20), from an inoperative position, in which it allows the liberation of said hinge pin (20) from its hinge seat (10), to an operative position, in which it begins to cooperate with the second stop means (25), avoiding said hinge pin (20) from being liberated from its hinge seat (10), regardless of the positioning of the locking slide (30).

2. The hinge arrangement according to claim 1, characterized in that, after a certain additional rotation for opening the door (P) from said side, the first stop means (15) of the other side also begins to cooperate with the respective hinge pin (20), avoiding the latter from being liberated from its hinge seat (10).

3. The hinge arrangement according to any of the claims 1 or 2, characterized in that the first stop means (15) is defined by a semi-circular projection incorporated to each hinge seat, the second stop means (25) being defined by a semi-circular wall, whose inner radius of curvature is larger than the external radius of curvature of the first stop means (15), which is concentric and spaced from a respective hinge pin (20) by a distance slightly larger than the radial thickness of the first stop means (15).

4. The hinge arrangement according to claim 3, characterized in that the first stop means (15) is internally coincident with the contour of the portion of the hinge seat (10) that retains a respective hinge pin (20) in the closed position of the door (P).

5. The hinge arrangement according to claim 3, characterized in that the hinge seat (10) takes the form of a slot, and in that, when the door (P) is in the closed position, the first and the second stop means (15, 25) have the same axis of symmetry coinciding with the axis of the slot of the hinge seat (10), the chord of the second stop means (25) cutting the end portions of the first stop means (15), which is kept substantially concentric in relation to both the hinge pin (20) and the second stop means (25).

6. The hinge arrangement according to claim 5, characterized in that the first stop means (15) is angularly displaced when the opposite side of the door (P) is opened, in order to be progressively inserted between the hinge pin (20) and the second stop means (25) as the door is progressively opened.

7. The hinge arrangement according to any of the claims 1 to 6, characterized in that each end of a locking slide (30) has a ramp (36), which is provided in the V shaped cut (33) so that, upon contacting a hinge pin (20) when the respective side of the door (P) is closed, it forces the locking slide (30) to move to the other side.

8. The hinge arrangement according to claim 1, characterized in that it further comprises support elements (60), each defined by a rolling element (61), which is rotatively and partially lodged in a frame (62) to be affixed to one of the parts defined by the door (P) and the cabinet (G), in order to cooperate with a surface of the other of said parts, when the door (P) is conducted to the closing position, guaranteeing the correct leveling of the door (P) in the closing operation, regardless of the amount of products that said door is supporting internally.

9. The hinge arrangement according to claim 8, characterized in that the rolling element (61) is defined by a ball.

10. The hinge arrangement according to any of the claims 1 to 7, characterized in that at least one pair of hinge seats (10), horizontally leveled, are formed on a seating plate (1), while the respective pair of hinge pins (20) are incorporated in a support plate (2).

11. The hinge arrangement according to claim 10, characterized in that the seating plate (1) carries a plurality of rollers (18), which are free rotating and with the contour of their cylindrical surface slightly projecting outwardly from the free external face of the seating plate (1), the support plate (2) having a front edge in the form of a ramp, in order to receive the rollers (18) when the door (P) is closed and to conduct the latter to the correct leveling before the closing operation is completed.
